(19) United States
(12) Patent Application Publication
(10) Pub. No.: US 2025/0069051 A1
(43) Pub. Date: Feb. 27, 2025

(54) PERSONAL CROSS-BORDER TRANSFER PROCESS SYSTEMS AND METHODS

(71) Applicant: Alterna Card Services, Inc., Sausalito, CA (US)

(72) Inventors: Madeleine Tapia, Roseville, CA (US); Joseph Seroussi, Fort Lauderdale, FL (US)

(73) Assignee: Alterna Card Services, Inc., Sausalito, CA (US)

(21) Appl. No.: 18/946,218

(22) Filed: Nov. 13, 2024

Related U.S. Application Data
(63) Continuation-in-part of application No. 17/868,552, filed on Jul. 19, 2022.

(51) Int. Cl. G06Q 20/10

(52) U.S. Cl. CPC G06Q 20/108

(57) ABSTRACT

Methods and systems for personal, trans-border transfer processes, also referred to as “Card to Card” transfers, that enable individuals who are customers of a financial program in Sender Country A to establish a direct link with the accounts of individuals in Recipient Country B for instant fund transfers, funds sharing or international bill payment.

### RELATED APPLICATION(S)

This application is a continuation-in-part application of U.S. application Ser. No. 17/868,552, filed Jul. 19, 2022, which is a continuation application of U.S. application Ser. No. 16/505,330, filed Jul. 8, 2019, which is a continuation application of U.S. application Ser. No. 15/256,407, filed Sep. 2, 2016, which is a continuation application of U.S. application Ser. No. 13/902,159, filed May 24, 2013, which claims the benefit of U.S. Provisional Application No. 61/655,948, filed Jun. 5, 2012, which applications are incorporated herein by reference.

### FIELD OF THE INVENTION

This invention relates to methods and systems for personal, trans-border transfer processes, also referred to as “Card to Card” transfers, that enable individuals who are customers of a financial program in Sender Country A to establish a direct link with the accounts of individuals in Recipient Country B for instant fund transfers.

### BACKGROUND OF THE INVENTION

Traditional prepaid debit cards require users to registering prior to receiving a personalized card. The registration requires the user to enter their social security number. This disadvantageously prevents users who do not have social security numbers from utilizing such a debit card.

A need exists for improved systems and methods for prepaid debit card issuance. A further need exists for improved systems and methods for in-store registration and sale of a one-time load fully flagged prepaid debit card which may trigger the issuance of a reloadable personalized fully flagged prepaid debit card and/or reloadable personalized ATM cards.

Remittances, usually understood as the money or goods that migrants send back to families and friends in origin countries, are often the most direct and well-known link between migration and development.

The current invention is a process method and system for achieving financial inclusion by providing users greater control over their personal financial management.

### ADVANTAGES AND SUMMARY OF THE INVENTION

An in-store registration and sale process may allow retail retailers to register and sell an instant issued, one-time load, fully flagged prepaid debit card which may trigger the issuance and mailing of a reloadable personalized fully flagged prepaid debit card and/or reloadable personalized prepaid ATM cards and to perform a one-time load of the instant issued card. The process may allow the retailer to: (1) Verify the CIP (“Customer Identification Program” as directed by the Card Act) documentation for non-U.S. citizens living in the U.S. who want to purchase a reloadable, personalized, fully flagged prepaid debit card; (2) Enter online the information required by the program manager and issuing bank for the approval, registration and sale of a one-time load, fully flagged prepaid debit card which triggers the issuance of a reloadable personalized fully flagged prepaid debit card as well as the issuance of reloadable personalized ATM cards and if real time approval occurs; and/or (3) Sell and load the instant issued one-time load fully flagged prepaid debit card. This process may also allow the same for U.S. Citizens to register for and purchase said cards in-store with an added step of calling the prepaid debit card company's PCI compliant customer service to provide the customer's Social Security Number.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

The personal cross-border transfer process, also referred to as “Card to Card” transfers, enables individuals who are customers of a financial program (typically a Prepaid Program Manager) in Country A (Sender Country) to establish a direct link with the accounts of individuals in Country B (Recipient Country). This process facilitates instant fund transfers from the Sender Country's account to the Recipient Country's account through a simple click on a digital application on a mobile phone or computer screen, or by calling customer service via phone. The received funds are immediately available to the Recipient for spending 24×7. Additionally, residents of Country B, typically friends and family members of individuals in Country A, can benefit from this process by receiving funds. The process also allows customers in the Sender Country to make fast and easy direct payments for goods and services rendered in the Recipient Country.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are used, and the accompanying drawings of which:

FIG. 1 shows a high level view of entities involved in system in accordance with an embodiment of the invention.

FIG. 2 shows an example of a system for debit card issuance in accordance with an embodiment of the invention.

FIG. 3 shows an example of a method for debit card issuance in accordance with an embodiment of the invention.

FIG. 4 shows additional steps that may be provided for a U.S. citizen for debit card issuance in accordance with an embodiment of the invention.

FIG. 5 shows the entities and processes involved and additional steps that may be taken for referral accounts enrollment for personal cross-border transfer process in accordance with an embodiment of the invention.

FIG. 6 shows the entities, cash flow and processes involved and additional steps that may be taken for money transfer and funds sharing for personal cross-border transfer process in accordance with an embodiment of the invention.

FIG. 7 shows the entities, cash flow and processes involved and additional steps that may be taken for international bill payment for personal cross-border transfer process in accordance with an embodiment of the invention.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

The invention provides systems and methods for debit card issuance. Various aspects of the invention described herein may be applied to any of the particular applications set forth below or for any other types of prepayment or financial applications. The invention may be applied as a standalone system or method, or as part of an integrated data aggregation or confirmation system. It shall be understood that different aspects of the invention can be appreciated individually, collectively, or in combination with each other.

### Definitions

Sender Country: The country where an individual, migrant, or citizen with family or friends in other countries resides.
Recipient Country: The country where an individual with family or friends in other countries resides.
Sender Country Program Customer (or Customer): An account holder with the Program in the Sender Country.
Recipient: The individual residing in the Recipient Country who will receive funds or payment for goods and services in the Recipient Country.
Remittance or cross-border money transfer: All transfers in cash or in-kind received by residents in Country B (Recipient Country) from an individual in Country A (Sender Country).
Program: A financial Prepaid Program designed to support immigrants and the underbanked in Sender Countries. It usually issues prepaid accounts with most of the features of a full-fledged account, including an associated VISA or Mastercard branded debit card issued by the Issuing Bank in the Sender Country.
Issuing Bank: The bank in the Sender Country that holds the deposits of the Program accounts (individual accounts or subaccounts of a Master Account) and issues Prepaid Cards if required.
Issuing Bank Processor: A financial processing entity that administers the Program accounts (or subaccounts of a Master Account) in the Sender Country. It is either owned by the Issuing Bank or subcontracted to a third party.
Corresponding Bank: A bank in the Recipient Country that is a partner of the Program and the Issuing Bank in the Sender Country. It supports the creation of Referral Accounts linked to the accounts of individuals, Customers of the Program in the Sender Country.
Corresponding Bank Processor or Sender Country Processor: A financial processing company that manages the Program accounts. It is either owned by the Issuing Bank or subcontracted to a third party.
Customer Front End: A digital application running on a mobile phone, computer, or accessible through customer service via phone.
Referral Account: An account or a digital wallet, with or without an associated physical debit card, that allows the Recipient to transact and move funds within the Recipient Country. It can be a normal bank account, a prepaid debit account, a digital wallet, or other financial instruments.
Direct Bill Payment or Direct Payment: The process by which an individual in the Sender Country performs fast and easy direct payments in the Recipient Country (usually their country of origin) for goods and services rendered in the Recipient Country. Examples include utility bills of family members, payment to build a house, loan servicing, and any other vendor or service provider available through API integration with local payment or financial networks in the Recipient Country.
Biller or Vendor: A provider of goods and services in the Recipient Country.
Payment Gateway: A payment infrastructure connected to service providers, vendors, financial institutions, or lenders in the Recipient Country, facilitating secure and efficient payment processing.

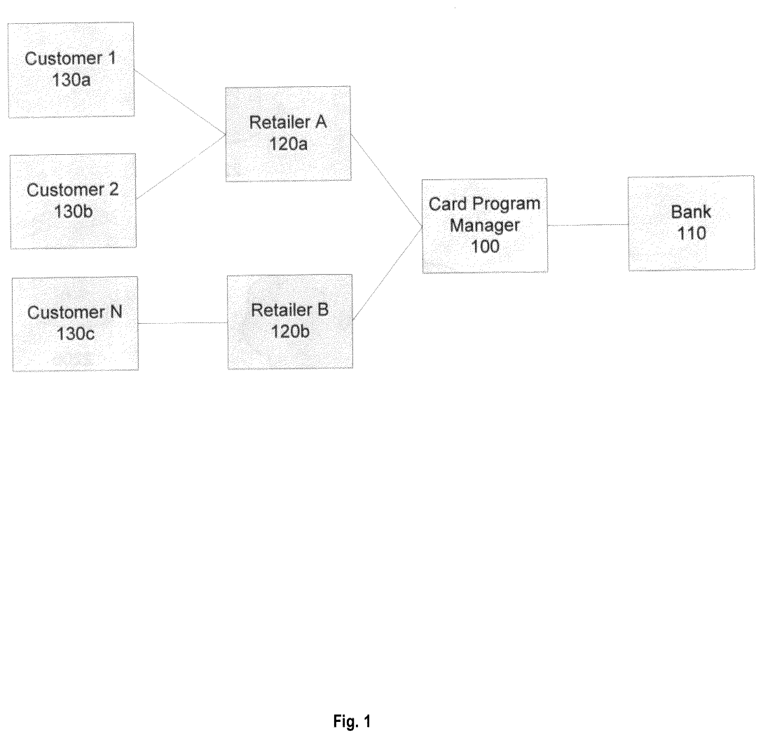

FIG. 1 shows a high level view of entities involved in system in accordance with an embodiment of the invention. A card program manager 100 may interact with a bank 110 and one, two or more retailers 120a, 120b. The one or more retailers may interact with one, two or more customers 130a, 130b, 130c. A card program manager may interact with any number of banks or retailers. Retailers may interact with any number of customers.

A program manager 100 of the card program may have a retailer 120a, 120b sign an agreement between the retailer, the issuing bank 110 of a prepaid debit card and the program manager for the selling and the loading of the cards. Said agreement may contain all credit information of the retailer required by the program manager and/or the issuing bank.

If the retailer is approved by the program manager and/or the issuing bank, a payment card industry (PCI) compliant prepaid debit card processor may assign a retailer ID to said retailer. The PCI compliant prepaid debit card processor may or may not be the same or different entity as the program manager and/or issuing bank. Each retailer may have a unique retailer ID. The retailer may or may not communicate directly with the issuing bank. In some instances, the retailer may or may not only communicate with the bank via the program manager.

Once the retailer is approved, issuing bank and/or program manger may certify a compliance officer of each retailer for the loading of the instant issued cards.

One or more customers 130a, 130b, 130c may interact with one or more retailers 120a, 120b. The customers may purchase, at the retailer, a non-personalized, single load, temporary card that is replaced via mail with a personalized permanent card. The retailer may be a point of sale for the customers to access the cards. The customers may be able to activate the card at the retailer site. In some instances, personalized reloadable cards may be sent to the customer's address. Personalized reloadable cards may be provided to the customer after a verification process has occurred. In some instances, the program manager may perform the verification for the customer. The verification may include verification of the customer's identity. Additional verification may incorporate the customer's financial status, and/or address.

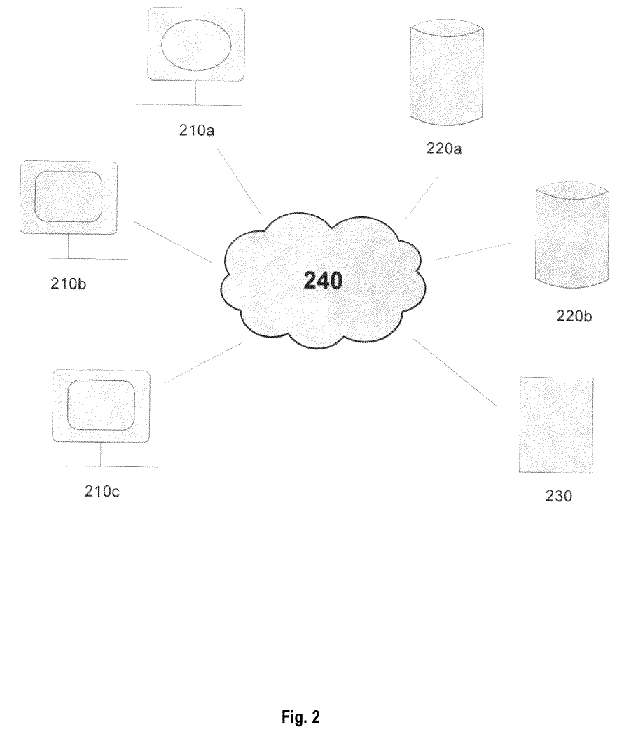

FIG. 2 shows an example of a system for debit card issuance provided in accordance with an embodiment of the invention. One or more device 210a, 210b, 210c may be in communication over a network 240 with one or more server 230 and/or database 220a, 220b.

In some embodiments, a device 210a, 210b, 210c may be a server, personal computer, laptop computer, tablet, mobile device, cell phone, satellite phone, smart phone (e.g., iPhone, Android, Blackberry, Palm, Symbian, Windows), personal digital assistant (PDA), pager or any other device. The device may be a device capable of communicating over a network. The device may have a memory and a programmable processor. The memory may store non-transitory computer readable media, which may comprise code, logic, or instructions for performing one or more steps described herein. The processor may execute one or more step. The device may be a telephone or other device capable of communicating with additional devices. The device may permit wired or wireless communication.

The devices may have a display that may permit a user interface to be displayed. The display may be a screen, touchscreen, LCD display, LED display, OLED display, CRT display, plasma display, or any other type of display. The display may permit visual depiction of information and/or audio depiction of information. A user interface may permit a user to interact with the system. For example, a user interface may be displayed for an online enrollment form where a retailer may enter information about a customer. The devices may be equipped with a camera, scanner, or other image capture device, or may be capable of receiving information from a camera, scanner, or other image capture device. The image capture device may capture an image of the customer and/or documentation from the customer. Such documentation may be useful for verifying the identity of the customer.

In some instances, the system may be a browser-based system. A web browser may be operating on the device. The browser may display a user interface through which a user may interact with the system. The user interface may permit a user to communicate with the server and/or databases.

The device may be used at a retailer site. For example, a retailer may provide in-store online registration of a card purchased by a customer. In some instances, one or more device may be used by a bank or card program manager in order to access information. In some instances, a customer may utilize a device to provide further registration and/or ordering personalized pre-paid ATM family cards.

One or more server 230 may communicate with the devices over a network 240. In some instances, the network may be a local area network (LAN) or wide area network (WAN) such as the Internet. The network may be any sort of telecommunications network, such as a cellular network or telephone line network.

A server 230 may have a memory and programmable processor. The server may be hosted and/or operated by a card program manager. Alternatively, the server may be hosted and/or operated by a bank, retailer, or any third party entity. The server may be capable of receiving information from the retailers and assisting with confirming the identity of one or more customers. The server may access information from one or more database 220a, 220b. The server may access information from the one or more databases in order to verify the identity of the customer. The server may compare the information received from one or more retailers with information stored in the databases. The server may provide new information to the databases.

The databases may or may not be owned and/or operated by the same entity as the server. The databases may be owned and or operated by a bank, card program manager, retailer, or any combination thereof. The databases may include public information, or information collected by a governing body or other entity. The retailers may or may not be able to access the databases directly. In some instances, the retailers may only access the databases via the card program managers. In some instances, information may be collected from public and/or governmental sources via web crawling or other forms of access. In some instances, an entity may be required to be authorized in order to access some of the information. The card program manager and/or bank may be granted authorized access to some of the information. The servers and/or devices may communicate with the databases over a network 240. In some alternate embodiments, a peer to peer architecture may be used, or cloud computing architecture may be provided.

A program manager may be capable of accessing the databases, thereby accessing information therein. The program manager may verify the identity of a customer and/or additional information relating to the customer. Such verification may occur with aid of a programmable processor. In some instances, verification may occur in an automated fashion without requiring human intervention. Alternatively, in some instances human intervention may occur.

The systems and methods may provide an in-store registration process, which may be for a dual card program where the customer may purchase a non-personalized, single load, temporary card that may be replaced via mail with a personalized permanent card. The CIP and Office of Foreign Assets Control (OFAC) verification may be performed at the time of purchase of the instant-issue card in the retail store via an in-store online registration interface that may be connected to the card's processor's platform so that the permanent card can be mailed to the customer. The customer may also have the option of ordering reloadable personalized prepaid ATM family cards at the time of purchase of the instant-issued card. No CIP may be required for the family card. In some instances, it is only necessary to perform an OFAC check on the individual whose name appears on the family card.

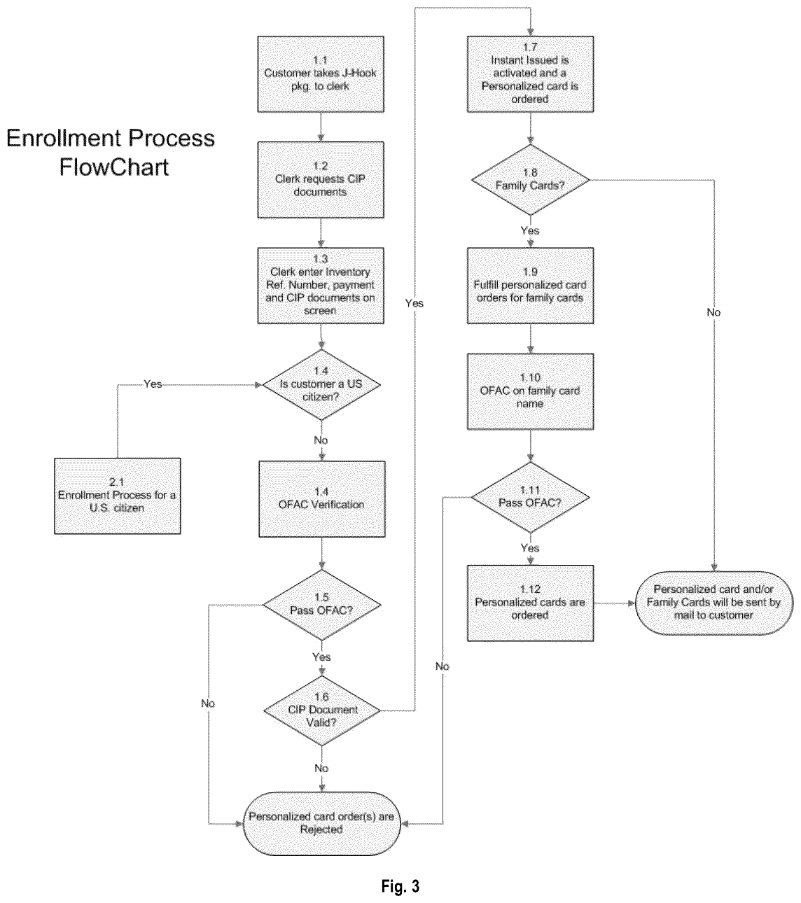

FIG. 3 shows an example of a method for debit card issuance in accordance with an embodiment of the invention. In some instances, the method may permit the issuance of a prepaid temporary card and/or personalized reloadable cards without requiring that the customer be a U.S. citizen (or citizen of the country of issuance of the card). The method may permit the issuance of cards to an individual who may not have a U.S. Social Security number. The method may permit the use of cards in the United States (or the country of issuance of the card). In other embodiments, the cards may be used outside the United States (or the country of issuance of the card). Such a method may operate in compliance with governmental and other regulations.

A customer may take a package to a clerk 1.1. The package may be for a non-personalized temporary card. The package may be provided at a retailer site.

The clerk may request identification and/or documentation from the customer 1.2. The clerk may request any sort of document that may verify the identity of the customer. For example, a driver's license, green card, passport, social security card, employment card, mail, or any other documentation may be requested. In some embodiments, the documentation may be CIP documentation. In some embodiments, the customer may complete a short enrollment form. The program manager may be responsible for printing and stocking the enrollment forms in the store. The program manager may send or provide the enrollment forms to the retailer site. Information about the customer may be collected. For example, one or more of the following: the customer name, address, phone number, date of birth, place of birth, country of citizenship, social security number, passport information, driver's license information, or any other type of information may be collected.

The clerk may enter data and/or send data based on data received from the customer 1.3. For example, the store clerk may enter the data from the enrollment form into an online form. This data may be entered manually. Alternatively, the clerk may ask the customer verbal questions and enter the answers into the online form. In another example, the customer may enter information into the online form, under or not under the supervision of the store clerk. The online form may be displayed on a device of the retailer. The store clerk may access the online form via a browser or application of the device. In some embodiments, the data provided into the online form may include an inventory reference number, payment, and/or CIP documents, or information from such documents.

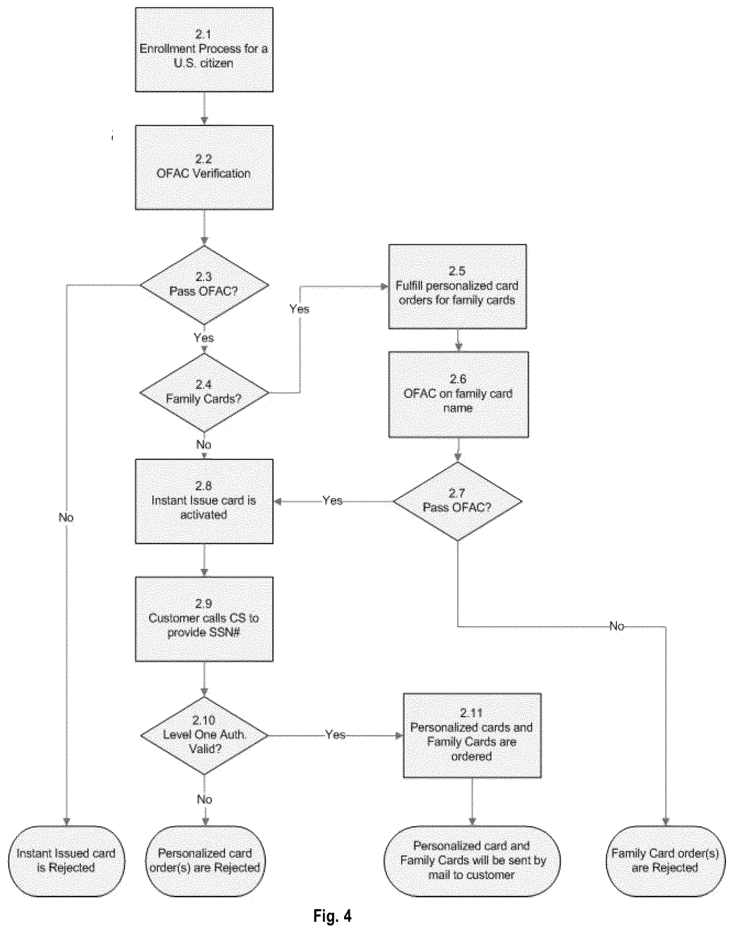

It may be ascertained whether the customer is a U.S. citizen 1.4. The online form may include a checkbox for U.S. citizenship. Customers that are U.S. citizens may be required to have a social security number (SSN) before a replacement reloadable personalized card can be shipped to the cardholder. FIG. 4 provides examples of steps that may be utilized for U.S. citizens 2.1.

If the customer is not a U.S. citizen, OFAC verification may occur 1.4. Non-U.S. citizens may not have a social security number (SSN). Customers who are citizens of other countries but do not have a U.S. SSN can provide alternate documentation that is acceptable to a Bank Sponsor. Thus, the identity of the customer may be verified without requiring a social security number and/or citizenship. In some instances, documentation that may be sufficient for OFAC verification may be sufficient for a bank sponsor. One, two, three or more of the following documents may be provided: Matricula Consular, non-U.S. Passport, foreign driver's license, foreign military ID, and/or unexpired government issued photo ID from customer's country of origin. The customer may be capable of providing documentation and/or other forms of identification that may comply with governmental regulations and/or authorities. The clerk may check a box on the online screen confirming that he or she has reviewed the document.

It may be determined whether the customer passed OFAC verification 1.5. If the customer did not pass, the personalized card order(s) may be rejected. If the customer did pass, then it may be verified whether the customer's CIP documents are valid. This may be valid on the back-end by comparing data from the CIP documents with information stored in one or more databases.

Since the customer has been verified by a documentary CIP method technically, it may be unnecessary to run a full Experian Level One check on these customers. However a full OFAC check can optionally be run. However, lack of SSN will not be a reason for rejection when another document is provided and the only thing needed from the Experian check is that the U.S. address given by the customer is a valid U.S. address. It is not necessary that the Experian check verify that the customer lives at that address. If the OFAC check is successful and the address given by the customer is a valid U.S. address, the replacement card order may be released for fulfillment. The customer may still have use of the Instant Issue card.

If the CIP document is found to be valid 1.6, then an instant issued card may be activated and a personalized card may be ordered 1.7. The instant issued card may be provided to the customer at the retailer site and may be immediately ready for use. The personalized card may be mailed to the customer.

To sell the Instant Issue card, the clerk may be required to enter the reference number on the card package into the system. The clerk may also enter the amount that is being loaded.

Orders for personalized replacement cards may be placed in a “pending” status if Experian Level 1 check for U.S. Citizens and OFAC for non-U.S. Citizens is unsuccessful. These orders will not be released until the cardholder and the Customer Service Rep. have successfully resolved the issue.

In some instances, an option to purchase family cards 1.8 may be provided. If no family cards are desired, only the personalized card may be mailed to the customer. If family cards are desired, then the system may fulfill personalized card orders for family cards 1.9.

In some instances, an OFAC verification may be performed in order to permit the family cards to be provided 1.10. The OFAC verification need not be performed on every member of the family. In some instances, the OFAC verification is only performed for the name that is provided on the family card. This may or may not be the same individual as the customer at the retailer site.

It may be determined whether the information provided for the family cards passes OFAC 1.11. If OFAC is not passed, then the family card order(s) may be rejected. In some instances, orders for family cards may be placed in a “pending” status if Experian Level 1 check for U.S. Citizens and/or OFAC for non-U.S. Citizens is unsuccessful. These orders will not be released until the cardholder and the Customer Service Rep. have successfully resolved the issue.

If the OFAC is passed, then personalized cards may be ordered 1.12. The personalized cards ordered may include family cards.

FIG. 4 shows additional steps that may be provided for a U.S. citizen for debit card issuance in accordance with an embodiment of the invention.

An enrollment process for a U.S. citizen 2.1 may occur. The enrollment process may include one or more steps described in the process above. For example, a U.S. citizen may desire to purchase a pre-paid debit card. The U.S. citizen may be at a retailer site and may purchase the card at the retailer site. The U.S. citizen may provide documentation relating to the U.S. citizen's identity. The documentation may be provided at the retailer site.

OFAC verification may occur 2.2. The OFAC may include comparing the documentation and/or information provided by the individual at the retailer with stored information. The stored information may or may not be provided remotely. The stored information may be accessed via a device at the retailer site, over a network.

It may be determined whether the individual passed OFAC 2.3. If OFAC was not passed, then the personalized card order(s) may be rejected. In some instances, orders for personalized cards may be placed in a “pending” status if Experian Level 1 check for U.S. Citizens and/or OFAC for non-U.S. Citizens is unsuccessful. These orders will not be released until the cardholder and the Customer Service Rep. have successfully resolved the issue.

If the individual did pass OFAC a call to customer service (CS) may be made to provide the SSN 2.4. For customers with a SSN, the store clerk may enter all of the data into the system with the exception of the Social Security Number. In some instances, the store clerks should not have access to SSN information. The customer may be instructed to call customer service to provide the SSN. The customer service may be hosted and/or operated by the card program manager, bank, or a third party entity. The customer may do so immediately or may wish to do so after leaving the store. In any case, the OFAC may be run and the Instant Issue card may still be sold and loaded, but the permanent card will not be shipped until enrollment has been completed. Cardholders may be able to complete the enrollment process by phone.

It may then be determined whether the SSN is valid 2.5. Such call and/or determination may be made at the retailer site, possibly in the presence of the customer. Alternatively, such call and/or determination may be made after departure of the customer with the instant access card. Such determination may be made at a location remote to the retailer site. In some instances, the retailer, program card manager, and/or bank may participate in making such a determination.

If the SSN is determined to be valid, an instant issued card may be activated and a personalized card may be ordered 2.6. The instant issued card may be activated while the customer is at the retailer. The customer may be able to use the card instantly.

Once the customer has provided a SSN to the program manager's customer service, the Experian Level 1 verification may be performed. If successful, the permanent replacement card may be fulfilled. If not, the customer may have to contact Customer Service to attempt to resolve the issue. The customer may still have use of the Instant Issue card and the customer will be refunded onto the instant-issue card if the permanent replacement card cannot be fulfilled. The customer may also be refunded onto the instant-issue card any monies paid for family cards if the permanent replacement card cannot be fulfilled.

In some instances, an option to purchase family cards 2.7 may be provided. If no family cards are desired, only the personalized card may be mailed to the customer. If family cards are desired, then the system may fulfill personalized card orders for family cards 2.8.

In some instances, an OFAC verification may be performed in order to permit the family cards to be provided 2.9. The OFAC verification need not be performed on every member of the family. In some instances, the OFAC verification is only performed for the name that is provided on the family card. This may or may not be the same individual as the customer at the retailer site.

It may be determined whether the information provided for the family cards passes OFAC 2.10. If OFAC is not passed, then the family card order(s) may be rejected. In some instances, orders for family cards may be placed in a “pending” status if Experian Level 1 check for U.S. Citizens and/or OFAC for non-U.S. Citizens is unsuccessful. These orders will not be released until the cardholder and the Customer Service Rep. have successfully resolved the issue.

If the OFAC is passed, then personalized cards may be ordered 2.11. The personalized cards ordered may include family cards.

Data handled herein may meet the payment card industry data security standard (PCI DSS).

### Personal Cross-Border Transfer Process, or “Card to Card” Transfers

### Referral Enrollment Process:

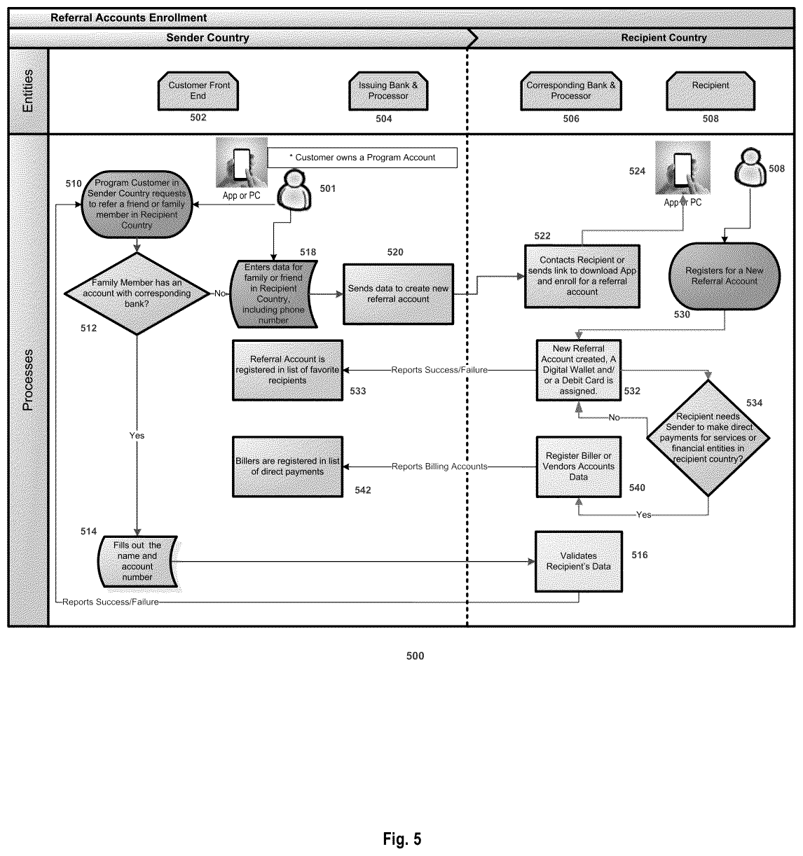

FIG. 5 shows the entities and processes involved and additional steps that may be taken for referral accounts enrollment for personal cross-border transfer process 500 in accordance with an embodiment of the invention.

1. At the time of enrollment in the Program or at a later stage, the Customer 502 in the Sender Country can choose to refer a friend or family member in the Recipient Country in step 510.

2. If the Referral Recipient already has a registered account with the Corresponding Bank in the Recipient Country step 512, the Customer only needs to enter the Recipient's name and account number at the Corresponding Bank in step 514.

3. If the Referral Recipient does not have a registered account step 512, the Customer can either:
a) provide the Recipient's basic information, including name, phone number, and any additional information required by the Corresponding Bank to comply with the regulations of the Recipient Country in step 518. The Corresponding Bank or the Recipient Country Processor, on behalf of the Corresponding Bank, contacts the Recipient to assist them in enrolling for their own account and setting up a Referral Account in step 520. The contact is made by sending a link via text messaging, mail, or any other means to download the app or open a web page in step 522, or
b) directly make an initial enrollment of the Recipient via an App of the Corresponding Bank in step 524. Recipient can later upgrade his account providing additional information as required by the Corresponding Bank or the Recipient Country Processor

4. The Referral Account can be any financial instrument that allows the Recipient to transact and move funds within the Recipient Country, such as a normal bank account, a credit union account, savings and checking accounts, brokerage accounts, a prepaid debit account, a digital wallet, or a local payment network, with or without an associated physical debit card issued by the Corresponding Bank on an international or local payment network step 532.

5. Once the Corresponding Bank or the Recipient Country Processor verifies that the Referral Account has been created, it informs the Issuing Bank or the issuing bank processor, which then registers a new entry on the list of Recipients in the Customer's front-end device (List of Favorite Recipients on a mobile or web application), step 533.

6. After the Referral Account is created, the Recipient has the option to add one or more Service Providers or Vendors in step 540 to allow the Sender to make fast and easy direct payments in the Recipient Country for goods purchased and services rendered. When the Recipient provides information about these accounts, the Corresponding Bank or the Recipient Country Processor validates the data and reports back to the Issuing Bank/Processor in the Sender Country, which creates a new entry on the list of Direct Payments in the Customer's front-end device (List of Favorite Direct Bill Payments on a mobile or web application), step 542.

7. At the end of the Referral Enrollment process, two accounts in the Sender and Recipient Countries are linked and preapproved for electronic funds transfer. This link can be invoked at any time to transfer funds without any additional third-party intervention, as long as the velocity parameters and amount limits comply with the rules dictated by regulating entities in both countries.

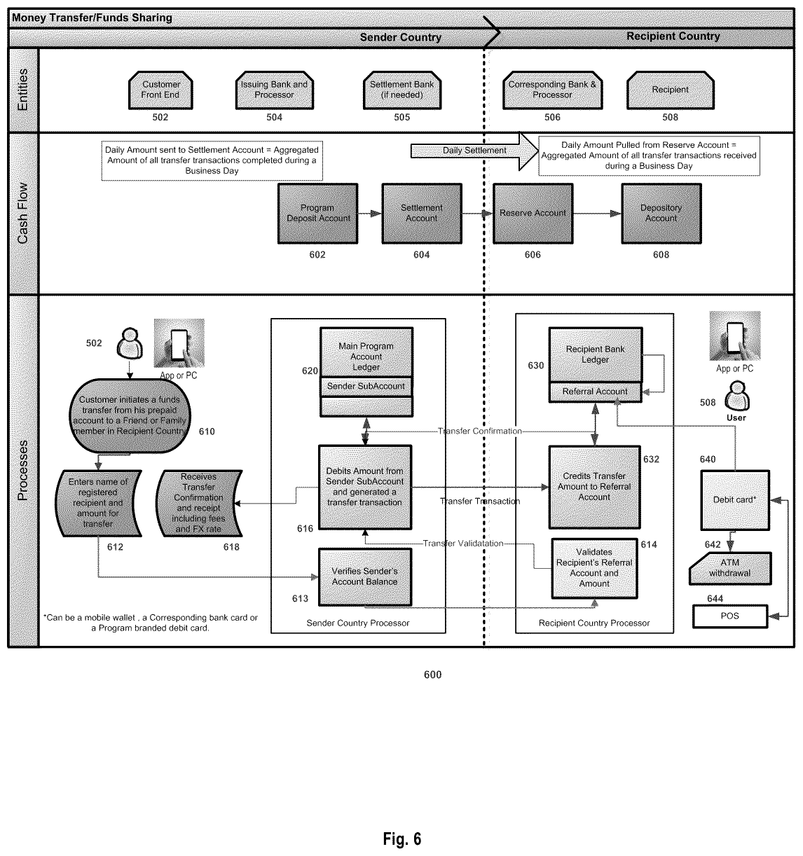

FIG. 6 shows the entities, cash flow and processes involved and additional steps that may be taken for money transfer and funds sharing for personal cross-border transfer process 600 in accordance with an embodiment of the invention.

### Transfer Process Steps:

1. The Customer 502 logs into their account using the Customer Front End in step 610, navigates to the “Move Money” section or to a “Money Transfer App”, selects one of the referral accounts from their list of favorite recipients, and enters the desired amount of money to send in step 612.

2. The Sender Country Processor verifies if the Customer has sufficient balance in their Program account to cover the transfer amount and associated fees in step 613. If approved, the collected information for the requested transfer is sent to the Recipient Country Processor.

3. The Recipient Country Processor validates the Recipient account data in step 614, approves the transfer amount within the allowed limits, and authorizes the transfer to the Sender Country Processor in step 616.

4. The Sender Country Processor proceeds with the transfer execution. It debits the transfer amount plus fees from the Customer Account/Sub Account in step 616, records a debit entry on the Program General Ledger in step 620, and sends the transaction to the Recipient Country Processor in step 632.

5. The Recipient Country Processor receives the transaction, credits the Referral Account, records a credit entry on the Referral Account General Ledger in step 630, makes the amount immediately available to the Recipient in step 640, and sends a transfer confirmation and receipt showing the amount received by the Recipient's account and associated fees back to the Customer Front End through the Sender Country Processor in step 618.

6. The Recipient 508 can choose to keep the money in their digital wallet/account or withdraw cash from an available cash-out facility or ATM in the Recipient Country in steps 640, 642 and 644.

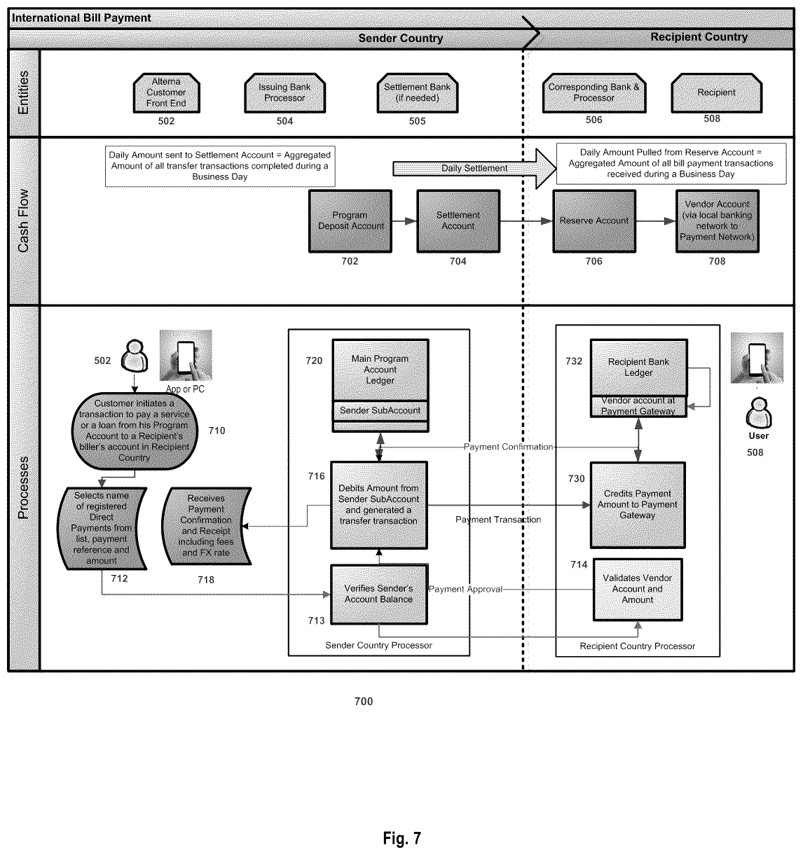

FIG. 7 shows the entities, cash flow and processes involved and additional steps that may be taken for international bill payment for personal cross-border transfer process 700 in accordance with an embodiment of the invention.

### Direct Payment Process:

1. The Customer 502 logs into their account using the Customer Front End in step 710, accesses the “International Direct Payments” section, selects one of the Service Providers or Vendors from their list of registered Direct Payments, and enters the payment reference or concept and the payment amount in step 712.

2. The Sender Country Processor verifies if the Customer has sufficient balance in their Program account to cover the payment amount and associated fees in step 713. If approved, the collected information for the requested payment is sent to the Recipient Country Processor.

3. The Recipient Country Processor validates the Recipient account data in step 714, approves the payment amount within the allowed limits, and sends the information for validation and approval to the Payment Gateway in step 716.

4. If the payment is approved, the Recipient Country Processor sends a message to the Sender Country Processor, approving the payment in step 718.

5. The Sender Country Processor proceeds with the payment execution. It debits the payment amount plus fees from the Customer Account/Sub Account in step 716, records a debit entry on the Program General Ledger in step 720, and sends the transaction to the Recipient Country Processor.

6. The Recipient Country Processor receives the transaction in step 730, credits the Vendor's account in step 732 through the Payment Gateway, and upon payment confirmation, sends a payment confirmation and receipt showing the amount paid and associated fees back to the Customer Front End through the Sender Country Processor in step 718.

### Money Flow Process:

This process runs in the background and ensures real-time availability of funds to recipients of transfers or payments. The aggregated amount of all transfers and Direct Payment transactions completed during any business day to a specific Recipient Country is moved from the Program Account in the Sender Country 602 to a Settlement Account 604, referred to as the daily settlement amount. The daily settlement amount is then transferred to a reserve account 606 controlled by the Corresponding Bank. The Corresponding Bank withdraws from the Reserve Account the aggregated amount of all transfers and Direct bill payment transactions received during a business day to cover the amounts credited to Referral Accounts or payments to depository account 608 of Vendors and Service Providers.

It is to be understood that the present invention is not limited to the embodiments described above, but encompasses any and all embodiments within the scope of the following claims. It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

I claim:

1. A system for personal, trans-border funds transfer processes, also referred to as “Card to Card” transfers, that enable individual users who are customers of a financial institution in a sender country to establish a direct link with the accounts of individual users in a recipient country for instant fund transfers, the system comprising the following:
a sender user and a sender's financial institution located in a sender country;
a recipient user with a recipient financial institution in a recipient country;
means for enrolling a referral account whereby the sender user in the sender country refers a family member or friend acquaintance to the system by submitting the name of the recipient user and the and the recipient user's account number at the recipient financial institution, if the recipient user has an account at the recipient financial institution the system validates the recipient's data, and reports a successful enrollment back to the sender user and if the recipient user does not have an account at the recipient financial institution then the system sends the recipient's name and contact information to create a new referral account located at the recipient's financial institution, whereby the referral account is accessed by the recipient user; and
means for transferring money or otherwise sharing funds between the sender user and the enrolled recipient user, wherein the sender user initiates a funds transfer from his financial institution account to the financial institution of the enrolled recipient user in a recipient country by entering the name of the enrolled recipient and the amount of the transfer, the recipient's financial institution validates the recipient's referral account and amount of transfer, the sender's financial institution debits the amount of the transfer from the sender's subaccount and generates a transfer transaction which is logged on the sender's financial institution account ledger, the system credits the transfer amount to the recipient's referral account which is logged into the recipient's financial institution account ledger, and the transfer amount is then made available to the recipient user's debit card for withdrawal at an ATM or otherwise for use by the recipient user at a point of sale.

2. The system of claim 1, further comprising means for international bill payment, wherein individual users who are customers of a financial institution in a sender country establish a direct link with the accounts of individual vendors in a recipient country for instant payment of invoices, wherein the sender user initiates a bill payment from his financial institution account to the financial institution of the enrolled recipient vendor user in a recipient country by entering the name of the enrolled vendor recipient and the amount of the invoice to be paid, the vendor recipient's financial institution validates the recipient's vendor account and amount of payment or creates a new vendor account, the sender's financial institution debits the amount of the payment from the sender's subaccount and generates a transfer transaction which is logged on the sender's financial institution account ledger, the system credits the transfer amount to the vendor recipient's referral account which is logged into the vendor recipient's financial institution account ledger, and the transfer amount is then made available to the vendor recipient.

3. A personal cross-border transfer process that enables individuals who are customers of a financial program in a sender country to establish a direct link with the accounts of individuals in a recipient country, thereby facilitating instant fund transfers from the sender country's account to the recipient country's account through a simple click on a digital application on a mobile or other computer device, the process also allowing customers in the sender country to make fast and easy direct payments for goods and services rendered in the recipient country, the transfer process comprising the following steps:
an initial referral enrollment process, wherein:
the customer in the sender country chooses to refer a friend or family member in the recipient country, if the referral recipient already has a registered account with the corresponding bank in the recipient country, the customer only needs to enter the recipient's name and account number at the corresponding bank, and if the referral recipient does not have a registered account, the customer can either: a) provide the recipient's basic information, including name, phone number, and any additional information required by the corresponding bank to comply with the regulations of the recipient country, the corresponding bank or the recipient country processor, on behalf of the corresponding bank, contacts the recipient to assist them in enrolling for their own account and setting up a referral account, wherein the contact is made by sending a link via text messaging, mail, or any other means to download the app or open a web page, or b) directly make an initial enrollment of the recipient via an app of the corresponding bank, such that the recipient can later upgrade his account providing additional information as required by the corresponding bank or the recipient country processor; wherein the referral account can be any financial instrument that allows the recipient to transact and move funds within the recipient country, such as a normal bank account, a prepaid debit account, a digital wallet, or a local payment network, with or without an associated physical debit card issued by the corresponding bank on an international or local payment network, such that once the corresponding bank or the recipient country processor verifies that the referral account has been created, it informs the issuing bank or the issuing bank processor, which then registers a new entry on the list of recipients in the customer's front-end device, or list of favorite recipients on a mobile or web application;
and optionally, after the referral account is created, the recipient adds one or more service providers or vendors to allow the sender to make fast and easy direct payments in the recipient country for goods and services rendered, such that when the recipient provides information about these accounts, the corresponding bank or the recipient country processor validates the data and reports back to the issuing bank/processor in the sender country, which creates a new entry on the list of direct payments in the customer's front-end device or list of favorite direct bill payments on a mobile or web application, whereby at the end of the referral enrollment process, two accounts in the sender and recipient countries are linked and preapproved for electronic funds transfer, wherein the link can be invoked at any time to transfer funds without any additional third-party intervention, as long as the velocity parameters and amount limits comply with the rules dictated by regulating entities in both countries; and
transfer process steps comprising the following steps:
the customer logs into their account using the customer front end, navigates to the “move money” section or to a “money transfer app”, selects one of the referral accounts from their list of favorite recipients, and enters the desired amount of money to send;
the sender country processor verifies if the customer has sufficient balance in their program account to cover the transfer amount and associated fees, and if approved, the collected information for the requested transfer is sent to the recipient country processor;
the recipient country processor validates the recipient account data, approves the transfer amount within the allowed limits, and authorizes the transfer to the sender country processor.
the sender country processor proceeds with the transfer execution. It debits the transfer amount plus fees from the customer account/sub account, records a debit entry on the program general ledger, and sends the transaction to the recipient country processor; and
the recipient country processor receives the transaction, credits the referral account, records a credit entry on the referral account general ledger, makes the amount immediately available to the recipient, and sends a transfer confirmation and receipt showing the amount received by the recipient's account and associated fees back to the customer front end through the sender country processor, whereby the recipient can choose to keep the money in their digital wallet/account or withdraw cash from an available cash-out facility or ATM in the recipient country.

4. The process of claim 3, further comprising a direct payment process for trans-border payment of bills for goods and services, the process steps comprising:
the customer logs into their account using the customer front end, accesses the “international direct payments” section, selects one of the service providers or vendors from their list of registered direct payments, and enters the payment reference or concept and the payment amount;
the sender country processor verifies if the customer has sufficient balance in their program account to cover the payment amount and associated fees, and if approved, the collected information for the requested payment is sent to the recipient country processor;
the recipient country processor validates the recipient account data, approves the payment amount within the allowed limits, and sends the information for validation and approval to the payment gateway;
once the payment is approved, the recipient country processor sends a message to the sender country processor, approving the payment;
the sender country processor proceeds with the payment execution, it debits the payment amount plus fees from the customer account/sub account, records a debit entry on the program general ledger, and sends the transaction to the recipient country processor; and
the recipient country processor receives the transaction, credits the vendor's account through the payment gateway, and upon payment confirmation, sends a payment confirmation and receipt showing the amount paid and associated fees back to the customer front end through the sender country processor.
